(19) United States
(12) Patent Application Publication
(10) Pub. No.: US 2005/0269996 A1
(43) Pub. Date: Dec. 8, 2005

(54) System, apparatus, and method for generating force by introducing a controlled plasma environment into an asymmetric capacitor

(76) Inventors: Robert Chrysler Brennan, Austin, TX (US); L. Stuart Penny, Austin, TX (US)

Correspondence Address: LOCKE LIDDELL & SAPP LLP, 600 TRAVIS, 3400 CHASE TOWER, HOUSTON, TX, 77002-3095, US

(21) Appl. No.: 11/135,596

(22) Filed: May 23, 2005

Related U.S. Application Data
(60) Provisional application No. 60/573,884, filed on May 24, 2004.

(51) Int. Cl. H02J 1/00

(52) U.S. Cl. 320/166

(57) ABSTRACT

The present invention provides method, apparatus, and system that generates and uses a motive and other force by introducing a plasma environment into an asymmetric capacitor, resulting in a significant gain in force. This extraordinary increase in force allows the use of ionic motive and other forces to enter the realistic and practical application realm. In one embodiment, the energy field is energized by applying a system to increase a plasma density by ionizing the plasma environment in the energy field through electromagnetic radiation, by increasing the plasma temperature, or some combination thereof. In one embodiment, the invention also generates a flow of energy or plasma directed outward from the apparatus. The present invention can also provide the motive forces at substantially reduced voltage levels. The low voltage can reduce or eliminate negative effects the prior high voltage levels required to energize the asymmetric capacitor.

This application claims the benefit of U.S. Provisional Application No. 60/573,884, filed May 24, 2004.

### FIELD OF THE INVENTION

The present invention relates to asymmetrical capacitors. More particularly, the invention relates to generating a force using asymmetrical capacitors by introducing a controlled plasma environment.

### BACKGROUND OF THE INVENTION

Asymmetric capacitors are known to exhibit a net force when sufficient power is applied. An asymmetric capacitor is generally a capacitor that has geometrically dissimilar electrode surface areas. The electrical field surrounding an energized asymmetric capacitor creates an imbalanced force and therefore a motive force of a small magnitude. The challenge over the past decades has been the amount of energy required to produce the motive force, also known as thrust-to-power consumption ratio. Although lightweight, asymmetric capacitor models have demonstrated the ability to produce enough force to overcome the effect of gravity on their own mass, the amount of energy required has been prohibitive to make practical and commercial use of this feature. Another challenge is the “space charge limited current” saturation point (also referred to as “charged space limits”) or the limit of charged particles that a given volume of space can accommodate. The amount of particles in a given volume limits the amount of force that can be generated from such volume.

Various researchers have used ions and their movements to produce motive forces for a variety of reasons. Some U.S. patents describe electrostatic charges relative to motive forces in various environments. These patents are incorporated herein by reference. For example, U.S. Pat. No. 1,974,483, issued in September 1934 to Brown, relates to a method of producing force or motion by applying and maintaining high potential electrostatic charges in a system of chargeable masses and associated electrodes. U.S. Pat. No. 2,460,175, issued in January 1949 to Hergenrother, relates to ionic vacuum pumps that ionize molecules of gas and then withdraw the molecules by a force of attraction between the molecules and a conductive member energized with a negative potential. U.S. Pat. No. 2,585,810, issued in February 1952 to Mallinckrodt, relates to jet propulsion apparatus and to electric arc apparatus for propelling airplanes. U.S. Pat. No. 2,636,664, issued in April 1953 to Hertzler, relates to pumping methods that subject molecules of a gas to ionizing forces that cause them to move in a predetermined direction. U.S. Pat. No. 2,765,975, issued in October 1956 to Lindenblad, relates to movement of a gas without moving parts through corona discharge effects on the gas. U.S. Pat. No. 2,949,550, issued in August 1960 to Brown, relates to an electrokinetic apparatus that utilizes electrical potentials for the production of forces to cause relative motion between a structure and the surrounding medium. U.S. Pat. No. 3,120,363, issued in February 1964 to Gehagen, relates to a heavier than air flying apparatus and methods of propulsion and control using ionic discharge. U.S. Pat. No. 6,317,310, issued in November 2001 to Campbell, relates to methods and apparatus, discloses two dimensional, asymmetrical capacitors charged to high potentials for generating thrust.

A non-ionic use of air molecules across an airfoil to produce a lift is seen in U.S. Pat. No. 2,876,965, issued in March 1959 to Streib. This patent relates to circular wing aircraft capable of vertical and horizontal flight using the radial cross-section of the wing as an efficient airfoil.

Brown observed the non-zero net force of an asymmetric capacitor system in a vacuum environment. It appears that this phenomenon can be explained by considering the pressure on the electrode surfaces due to the charged ions evaporated from the electrodes in the absence of the charged ions created in a medium (air). Brown also observed that the force produces relative motion between the apparatus and the surrounding fluid dielectric medium, i.e., the dielectric medium is caused to move past the apparatus if the apparatus is held in a fixed position. Further, if the apparatus is free to move, the relative motion between the medium and the apparatus results in a forward motion of the apparatus. It is possible that these phenomena can be explained by the theory that the momentum transfer of charged ions to the electrode surfaces is the mechanism to produce the net propulsive force, because the energetic ions are redirected and move through and around the capacitor without losing any momentum if the system is held in a fixed position. If the system is free to move, there still will be ions flowing through and around the capacitor as a result of collisions but this flow should be much weaker than that in the case of fixing the system since the ions lose their kinetic energy and momentum through collisions with the electrode surfaces. Further, Klaus Szielasko (GENEFO www.genefo.org “High Voltage Lifter Experiment: Biefield-Brown Effect or Simple Physics?” Final Report, April 2002) observed that there was no difference in the motion of the device when the polarity of the system was reversed, thus establishing that the electrostatic force experienced by charged ions is not the mechanism of propulsion. Further guidance supporting the underlying principles can be obtained from Canning, Francis X., Melcher, Cory, and Winet, Edwin, Asymmetrical Capacitors for Propulsion, Glenn Research Center of NASA (NASA/CR-2004-213312), Institute for Scientific Research, October, 2004, published after the provisional application upon which this application claims the benefit.

The electrokinetic fields generated before the present invention have largely suffered from relatively high energy input yielding low output or net force. While the general concept of asymmetric capacitors and the use of ionic forces are known, the inability to produce sufficient motive force has eliminated many potential uses. Thus, the dilemma heretofore has been to increase the amount of conduction current in an ion processing propulsion system without increasing the power consumption, when the level of high-voltage required must be high enough to create the conduction current in the first place.

A further challenge has been the heretofore accepted high voltage input needed based on the above listed efforts and other similar efforts. However, the high voltage input has undesirable secondary effects. These effects include a substantial electromagnetic field and interference, static electricity buildup on surrounding objects, x-radiation, ozone production, and other negative effects.

Therefore, there remains a need for an improved asymmetric energy field to produce an improved motive force.

### SUMMARY OF THE INVENTION

The present invention provides method, apparatus, and system to generate a motive and other forces by introducing a controlled plasma environment into an asymmetric capacitor. A flow of energy or plasma is directed outward from the apparatus. The present invention uses the asymmetric aspects of the related energy field, but energizes the energy field by several orders of magnitude. This extraordinary increase in motive force is accomplished in part by increasing plasma density, plasma energy (and an equivalent plasma temperature) and related particle velocity, or a combination thereof. The increase allows the use of ionic motive forces for practical applications that heretofore has been unavailable.

In one embodiment, the energy field is energized by applying a system to introduce a controlled plasma environment in the energy field through electromagnetic radiation, such as with a laser or an annular array of light emitting diodes (LEDs). The energy field can be energized by increasing the plasma density, plasma energy and particle velocity, or a combination thereof. Further, the plasma environment can be energized prior to developing a significant asymmetric energy field. In yet another embodiment, the present invention significantly enhances forces at substantially reduced voltage levels using the electromagnetic radiation compared to the previously required voltage levels without the electromagnetic radiation. Advantageously, the low voltage can reduce or eliminate negative secondary effects caused by the heretofore prior high voltage levels required to energize the asymmetric capacitor engine.

The disclosure provides a method of providing a force with an asymmetric capacitor, comprising: applying electromagnetic radiation to particles in proximity to an asymmetric capacitor having at least two electrodes of different surface areas and separated by a distance; and applying voltage to at least one of the electrodes to generate a net force with the asymmetric capacitor.

The disclosure also provides a method of increasing power output from an asymmetric capacitor, comprising: ionizing particles with electromagnetic radiation in a medium between a first electrode having a first surface area and a second electrode having a second surface area different from the first surface area; and applying a voltage to at least one of the electrodes and generating a net force with the electrodes.

The disclosure further provides a system for producing a motive force, comprising: an asymmetric capacitor comprising a first electrode having a first surface area and a second electrode having a second surface area different from the first surface area; a voltage source coupled to the asymmetric capacitor to apply voltage to the capacitor and generate a net force with the capacitor; and an electromagnetic radiation source adapted to apply radiation to particles between the electrodes.

### BRIEF DESCRIPTION OF THE DRAWINGS

A more particular description of the invention, briefly summarized above, may be had by reference to the embodiments thereof, which are illustrated in the appended drawings and described herein. It is to be noted, however, that the appended drawings illustrate only some embodiments of the invention and are therefore not to be considered limiting of its scope, because the invention may admit to other equally effective embodiments.

FIG. 1 is a schematic view of an electromagnetic field environment created from an asymmetric capacitor and related system of the present disclosure.

FIG. 2A is a charged particle schematic diagram of the baseline asymmetric capacitor in a more simplified form to FIG. 1.

FIG. 2B is a charged particle schematic diagram of the asymmetric capacitor with applied electromagnetic radiation, illustrating increased particle density.

FIG. 2C is a charged particle schematic diagram of the enhancement of the present invention with electromagnetic radiation illustrating the resulting increased particle density and velocity.

FIG. 2d is a schematic diagram showing the volt-ampere characteristic of a Langmuir electrostatic probe.

FIG. 3 is a schematic diagram of a motive force of neutral particles momenta experienced collisions with charged particles.

FIG. 4 is a schematic diagram of one embodiment of an asymmetric capacitor engine.

FIG. 5a is a schematic diagram of a cross sectional view of one embodiment of a system using the asymmetric capacitor.

FIG. 5B is a top view schematic of the embodiment shown in FIG. 5A.

FIG. 6 is a schematic diagram of the power budget for one exemplary embodiment.

FIG. 7A is a schematic perspective view of one embodiment of an unmanned aerial vehicle (UAV).

FIG. 7B is a schematic top view of the embodiment of FIG. 7A.

FIG. 7C is a schematic side view of the embodiment of FIG. 7A.

FIG. 8A is a schematic perspective view of one embodiment of a manned aerial vehicle (MAV).

FIG. 8B is a schematic front view of the embodiment of FIG. 8A.

### DETAILED DESCRIPTION

The present invention relates to a system, method, and apparatus that generates a force from an asymmetric capacitor by applying electromagnetic radiation to particles between electrodes in the asymmetric capacitor to ionize the particles. The electromagnetic radiation generates a highly energized state, such as a plasma, in the capacitor for producing an increased force, such as a motive or other force emanating from the capacitor, compared with prior efforts. This force increase is achieved by controlling the plasma density, plasma energy or particle velocity, plasma temperature, negative electrode (cathode) surface area in relation to the anode, or a combination thereof.

The asymmetric capacitor, having different electrodes with different surface areas, gains a net force in the axial direction, that is, in the direction of the line from the large or negative electrode to the small or positive electrode. This force direction applies regardless of polarity of the supply voltage, because the directions of these net forces do not change when polarity is changed. The net force on the large or negative electrode is much larger than that of the small or positive electrode due to large differences in the surface area.

In general, the disclosure provides for applying external energy at favorable frequencies to excite particles into ions, or ions into more energetic ions, to create a plasma condition. The disclosure provides a relatively low energy input for a comparatively large force output by creating a plasma that can be manipulated between the electrodes of the asymmetric capacitor when voltage is applied to the electrodes. The term “plasma” is well known and is intended to include a high energy collection of free-moving electrons and ions, i.e. atoms that have lost electrons. Energy is needed to strip electrons from atoms to make plasma. The energy input to the particles for the plasma can be of various origins: thermal, electrical, or light (ultraviolet light or intense light from a laser). Without sufficient sustaining power, plasmas recombine into a neutral gas.

Overview of the Invention and Asymmetric Capacitor

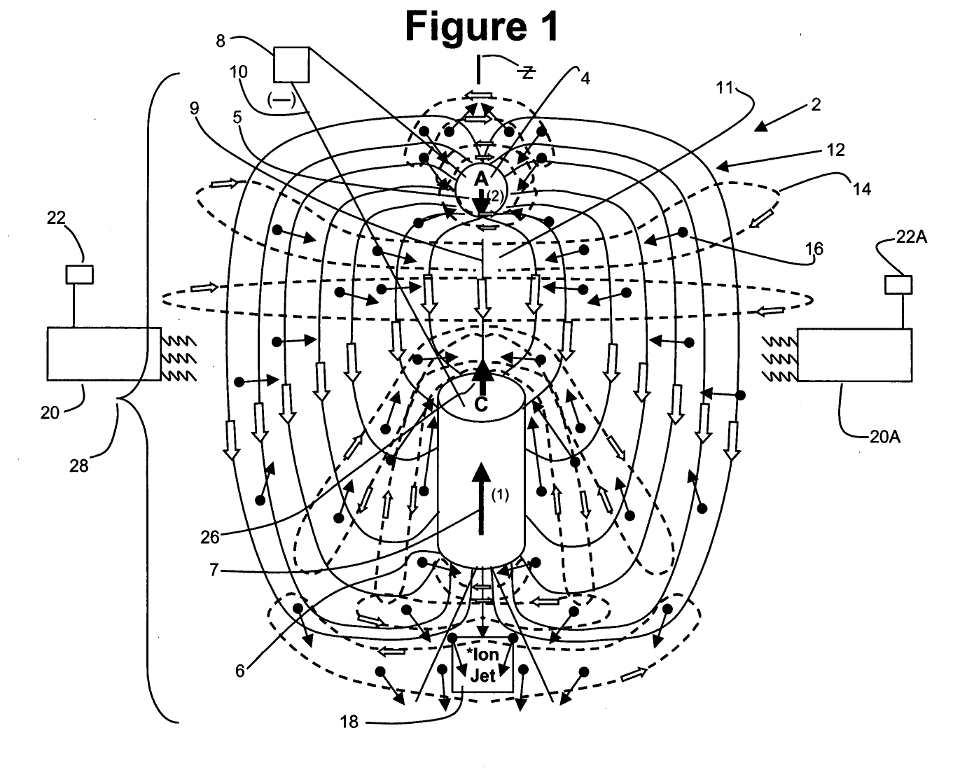

FIG. 1 is a schematic view of an electromagnetic field environment created from an asymmetric capacitor and related system of the present disclosure. The figure provides some understanding of the operation of an asymmetric capacitor to better understand the inventive improvement. The size of vectors (i.e., forces in a certain direction) representing the momentum transfer from charged particles is neither scaled nor accurate. The electromagnetic field lines are approximate.

An asymmetric capacitor 2 generally includes a first electrode 4 and a second electrode 6 separated by a distance through a media 11, including a gas, such as air, a vacuum such as space, or a liquid. Operation in the vacuum of space generally would advantageously use the injection of a media with particles. For operation in liquids, generally the engine will be energized and functioning with a plasma between the electrodes and be supplied with vaporized liquid, such as water vapor having properties of gases sufficient to ionize with associated collisions discussed herein. The first electrode has a first surface area calculated around the portion exposed to the media and the second electrode likewise has a second surface area. For an asymmetric capacitor, the surface areas are different. Further, the absolute size of each electrode and relative size of one electrode to the other electrode can cause a difference in net force generated with the electrodes. Generally, the first electrode is an anode and the second electrode is a cathode with the anode having a more positive charge (voltage) than the cathode. Generally, the cathode will have the larger surface area. The electrodes can be any geometric shape or combination with other shapes and have geometric patterns formed within one or more of the electrodes, such as openings and so forth. The anode can be, for example and without limitation, an emitter wire(s), blade(s), or disc(s), and the cathode can be a sheet(s), blade(s), or disc(s). The electrodes can be any suitable material, including copper, aluminum, steel, or other materials capable of establishing the electromagnetic field between the electrodes. Generally, the electrodes include conductive materials to establish the electromagnetic field. For some applications, weight, costs, conductivity, structural integrity, and other factors can determine the exact materials or combination of materials for a particular electrode. For example, and without limitation, a first material having a higher density and/or more conductivity can be applied over a lower density and/or less conductive material to create a composite electrode. Further, the electrodes can be a plurality of surfaces electrically coupled together to alter the surface area of the particular electrode. By convention, a positive voltage is applied to the anode through a power supply 8 and the cathode is negative in relation to the anode, although it is possible to reverse the polarity. In some embodiments, voltage can be applied to both electrodes with the anode generally having a more positive potential. Alternating current (AC) and direct current (DC) can be used.

When voltage is applied to at least one of the electrodes, such as the anode, an electromagnetic field is created between the electrodes because the media therebetween is relatively non-conductive compared to the electrodes. For present purposes, the field is discussed in terms of an electric field 12 having electric field lines of varying strength that at a center point between the electrodes are generally parallel to a line 9 drawn between the electrodes and bend and even reverse near the electrodes. The magnetic field 14 has magnetic field lines that are generally perpendicular to the electric field lines at any particular point on the electric field lines. Thus, at the center point between the electrodes, the magnetic field lines will be generally perpendicular to the line 9. The electric field serves to energize particles 16 in the media, creating ions of some charge value and the magnetic field serves to attract the ions in the direction of the magnetic field at the particular location of the ion. Because the electric and magnetic fields extend beyond a straight line from electrode to electrode, particles beyond the straight line and surrounding the electrodes can also be affected. Thus, such particles surrounding the electrodes can be included in the volume defined broadly herein as “between” the electrodes, as shown in the electromagnetic field region 28. The term “particle” is used broadly herein and includes both neutral particles and charged particles (that is “ionized”) particles, unless the particular context directs otherwise. The particles can be molecules or atoms or subatomic particles such as electrons, neutrons, and protons, and other subatomic particles.

More specifically, when a voltage is applied to the asymmetric capacitor 2, the conductive current runs from the smaller or positive electrode 4 to the larger or negative electrode 6. According to Ampere's law, this conductive current creates an azimuthally magnetic field surrounding the capacitor. For clarification, cylindrical coordinates are applied in this system by taking the axial direction in the direction of the line 9 from the negative electrode to the positive electrode. The “daughter” charged particles are created in the medium, generally air, or water vapor or other introduced medium as described herein, and evaporated or otherwise emitted from the electrode surfaces due to collisions with the “parent” electrons and ions, experience a Lorentz force (j×B or enV×B) in addition to the force due to the prescribed electric field (eE), where vector quantities are expressed in the bold letters. Here, “parent” is intended to mean the original charged particle carrying the conductive current and “daughter” is intended to mean the secondary charged particle created by collisions with the parent charged particles. At the top and bottom of the electrode 6, the ions are pushed radially inward due to this Lorentz force (in cylindrical coordinates: −z×−φ=−r, where (z) represents the axial component of the electric field, (φ) represents the direction of the magnetic field, and (r) represents the direction of motion of ions).

On the upper flat surface of the electrode 6, the ions are pushed upward due to this force (−r×−φ=−z), where the upward direction is the direction toward the smaller relatively positive electrode 4. On the region closer to the top surface, the ions are pushed to the radially inward and upward direction. Upward movements of the ions are reversed on the lower surface of the larger or negative electrode 6 due to the reversed directions (φ) of the axial component (z) of the electric field at the bottom of the electrode and this in turn reverses the direction (φ) of magnetic field. The forces in this region are considered weaker than those in the upper region as being further away from the first electrode 4, resulting in a net force in the direction of the axial component (z). Ions near the more positive, smaller electrode 4 experience similar movements, but in the opposite direction of the axial component (z).

A motive (that is, thrust) force is the net force from the pressure (created by collisions with energetic ions) all over the body surface of the particular electrode, resulting in the net force 5 on the electrode 4 and the net force 7 on the electrode 6 in the opposite direction to net force 5 on the first electrode 4. The net forces for each electrode are aligned in the direction of the line 9, but in an opposite direction (that is, along a z axis in a coordinate axis system). The net force on the electrode 6 is larger than that of the electrode 4 because of the differences in electrode surface area. The whole system using an asymmetric capacitor gains a resultant net force 26 by the vector sum of the forces 5, 7 in the axial direction of line 9, i.e., in the direction of the line from the negative or larger electrode to the positive or smaller electrode, regardless of polarity of the supply voltage.

Although movements of associated electrons are completely opposite to those of the ions, the momentum transfer of the electrons is considered trivial and negligible compared to the momentum transfer of the ions. Thus, momentum transfer of the ions to neutral particles is considered the main mechanism to contribute to a net motive force. An ion jet 18 of particles is created in a direction away from the larger electrode 6 distal from the smaller electrode 4 that can further emanate a force from the capacitor.

The order of magnitude of the Lorentz force due to the magnetic field created by the conductive current is generally negligible compared to that of electrostatic force. However, it is believed that the Lorentz forces can be significant at local spots where a strong magnetic field is possible when the local current density of the plasma is dramatically increased from Ohmic heating and enhanced conductivity. At such spots, the order of magnitude can be mega-amperes per centimeter squared, so that the Lorentz force is comparable to or greater than the electrostatic force.

With the basic understanding of the operation of an asymmetric capacitor, attention is drawn to further discussion of the inventive aspects. In at least one embodiment, creating an enhanced ionized environment of particles within a volume of media between the asymmetric capacitor's electrodes enhances the charged particle density, temperature of the particles, or both. The enhanced charged particles can be raised to a plasma level environment that can be controlled in terms of plasma density and average plasma temperature (and therefore affecting particle velocity). The term “plasma” is intended to mean generally an electrically neutral, highly ionized gas composed of ions, electrons, and neutral particles. It is a phase of matter distinct from solids, liquids, and normal gases.

The enhanced ionized environment of particles can be created by providing electromagnetic radiation, such as ultraviolet radiation, infrared radiation, radio-frequency radiation, other frequencies, or a combination thereof, into the particles. The environment generally includes at least a partial plasma. One or more electromagnetic radiation sources 20, 20A can be used to provide such radiation. Advantageously, certain wavelengths of radiation can be used dependent on the particles to be ionized to raise the particles to a plasma state. The sources 20, 20A can be powered by one or more power supplies 22, 22A, which can be the same as the power supply 8.

The value of net forces derived from the asymmetric capacitor according to the teachings herein can be raised without increasing input power to the capacitor from the power supply 8. Naturally, input power is required for the electromagnetic radiation sources to ionize and perhaps create the controlled plasma environment. However, the net gain to the system can energize the electric field by a significant margin, and even by an order of magnitude or more.

The particles in the electromagnetic field created by the power to the electrodes can be further energized by applying electromagnetic radiation to the volume between the electrodes. The electromagnetic radiation can increase a plasma density between the electrodes, including the volume of particles within the electric field. The electromagnetic radiation can also increase the plasma temperature that increases particle velocities by using alternative sources of electromagnetic radiation. In some embodiments, the electric field can be increased both in plasma density and in temperature. Further, the electric field can be energized prior to developing a significant asymmetric energy field.

Increasing the plasma density and/or plasma temperature allows an increase in what heretofore has been a limiting factor on power output through the net force from an asymmetric capacitor system, despite many decades of effort. A term known as “space-charge-limited current,” described more fully below, is the maximum amount of charge from ions within a given space before saturation occurs and limits further charges. Increasing the saturation value can allow an increase in the net force and power output.

Prior efforts focused on high voltage with attendant limitations and complications. The inventors developed an alternative and improved method of increasing the plasma density and/or temperature with the attendant increase in saturation level by allowing a relatively low voltage to be used for the asymmetric capacitor and amplifying the energy to the particles through electromagnetic radiation of one or more wavelengths. The result was an unexpected non-linear response that greatly increased the net force as output from the asymmetric capacitor over any known asymmetric capacitor arrangement using the same voltage. In some embodiments, the increase was an order of magnitude or more. Advantageously, the low voltage can reduce or eliminate negative effects that heretofore resulted from the high voltage levels required to energize the asymmetric capacitor engine.

Further, the inventors determined that injecting particles into the electric field increases the generated force that the system of the present disclosure can accommodate due to the increased capacity to use additional particles by an increased saturation value. Injected particles can include gaseous particles, such as hydrogen, helium, or other gases and materials. The injection can be supplemental to the media in which the asymmetric capacitor operates or instead of such medium. Further, injecting particles can enhance the ability of the asymmetric capacitor to operate under less than standard conditions of pressure (1 atmosphere), such as the relative vacuum of space or other low or essentially no pressure conditions.

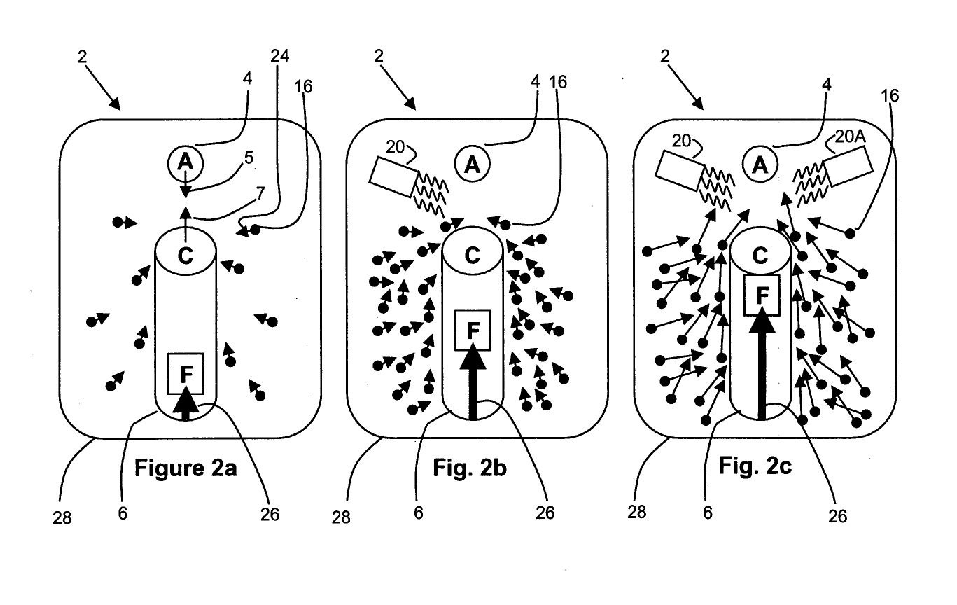

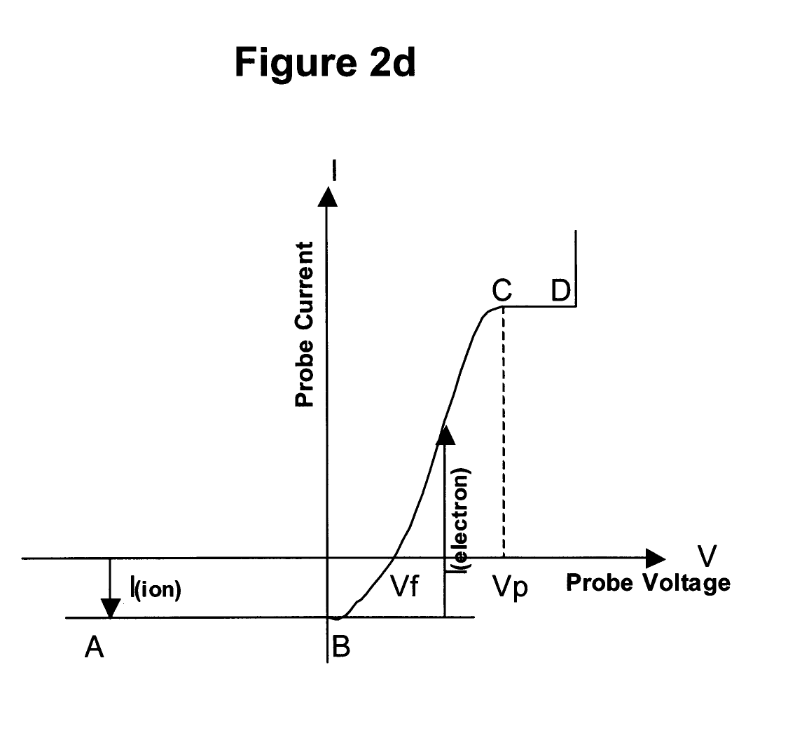

FIGS. 2A, 2B, 2C are schematic diagrams of an asymmetric capacitor with charged particles that contrast the significant enhancements to the vector sum of forces in accordance with the present teachings. FIG. 2A is a charged particle schematic diagram of the baseline asymmetric capacitor in a more simplified form to FIG. 1. A first electrode 4 and a second electrode 6 have different surface areas exposed to particles to be energized and form the basic asymmetric capacitor 2 configuration. The particles 16 between the electrodes (i.e. the particles in the electromagnetic field 28) have a certain density and velocity 24. The velocity is indicative of the energy level of the particular particle and hence temperature. As described in FIG. 1, the particle interactions create a net force on the asymmetric capacitor as a whole, illustrated as force 26.

FIG. 2B is a charged particle schematic diagram of the asymmetric capacitor with applied electromagnetic radiation, illustrating increased particle density. Applying electromagnetic radiation to the particles significantly provides increased power output in the way of a resultant net force with the asymmetric capacitor. It is believed the application of electromagnetic radiation increases the plasma density. The electrodes 4, 6 can be operated at a given power level. An electromagnetic radiation source 20 can apply electromagnetic radiation to the particles 16 to provide energy to the particles. More particularly, in at least one embodiment, the electromagnetic radiation can be applied with a laser, one or more light emitting diodes (LEDs), or other photon emission sources. The radiation is used to create at least a partial ionization of the media between the electrodes, including generally the media in which the asymmetric capacitor operates. Advantageously, the wavelength used by the laser can be a relatively short wavelength, such as infra-red (IR) and ultra-violet (UV) or shorter. For example, research into photo-ionization indicates that at specific frequencies of about or below 1024 nm for O₂ and about or below 798 nm for N₂, both of these atmospheric molecules will photo-ionize and become ready for manipulation by electrical fields in the same way as similar molecules ionized by high-voltage. Although the frequencies can vary with differing efficiencies of ionization, a commercially viable range of frequencies is believed to be about 750 nm to about 1024 nm for O₂, and from about 248 nm to about 798 nm for N₂. Such gas-specific frequencies are sometimes referred to as Fraunhofer frequencies. These harmonic frequencies cause the specific gas to ionize with relatively little energy input. Less energy to ionize the particles to prepare the plasma creation contributes to more force output per energy input unit.

Further, a combination of frequencies can be provided to the media. In the example above, if the media is air comprising largely oxygen and nitrogen, then energy at the specific frequency for each component can be applied to the media to achieve more efficient ionization. Still further, other electromagnetic radiation can be applied at various frequencies, some short wave and others long wave, which can add further energy to the particles. The frequencies can be applied simultaneously to the particles or in stepped fashion and in different sequences separate or in combination with a sequence of the voltage applied to the capacitor. Such simultaneous or sequenced application advantageously leads to a higher efficient to the engine.

Another source of radiation is to use a 248 nm laser with high energy femtosecond pulses to ionize the air (possibly an order of 10¹¹ particles/cm³). Further, the system can use a longer wavelength such as 750 nm IR to stabilize the plasma by reducing a plasma neutralization occurring undesirably by recombination with other particles to produce neutral particles that may not contribute to the force in any substantial way. The frequency or frequencies to be applied are exemplary and largely depend on the media in which the asymmetric capacitor is operated and the particular particles to be energized, as could be determined by one with ordinary skill in the art provided the guidance and disclosure contained herein without undue experimentation. Such person would generally include one skilled in physics, such as plasma physics. The disclosure generally provides for increasing efficiently the energy into the particles, through other than the prior single reliance on voltage across electrodes of the asymmetric capacitor, to create the plasma and to yield a relatively large force.

By ionizing the particles in the volume within and around the asymmetric capacitor with electromagnetic radiation, such as UV and/or IR light, the media density and energy is increased to the point that at least a partial plasma is produced. The plasma can be accelerated and steered by electric and magnetic fields, which allows it to be controlled and applied.

An increased plasma density and temperature has a double benefit: it provides a greater number of particles to cause molecular collisions and further ionization within the same volume; and the energy of the particles is also increased imparting greater energy during collisions. The increased capacity of ionization results in more impacts and a greater net force 26 compared to FIG. 2A.

The increased plasma density can allow a reduction in the voltage to the electrodes for a given net force and reduction of negative high-voltage effects. The lower voltage is possible because the UV or IR frequency or other electromagnetic energy is applied to the particles.

It is believed that the present invention also addresses two different limiting physical laws involved in saturation of space-charge-limited current. One type is the saturation of emission of electrons from the negative electrode, and is believed to include the emission of ions from the positive electrode as well. For example, this phenomenon can be observed in a vacuum diode. Generally, the emission rate of electrons from the cathode governs a saturation of space-charge-limited current since this emission rate is limited by thermionic emission from a heated cathode. This means that the emission rate seems to reach its maximum value at a certain applied voltage.

A second type of saturation is the saturation of the electron density (and the ion density as well) in the plasma sheath region surrounding the electrode. It is believed that this second saturation is more dominant for the asymmetric capacitor case than the first saturation mentioned, because the medium (such as air) is ionized to form plasma by collisions with the parent charged particles.

Below is a brief explanation of a general phenomenon that a plasma exhibits near the surface of a structure (in this case, the surface of the electrode). Plasma tends to shield out its electrical potentials that are applied to it and the edge of this shielding changes based on the density and temperature of the plasma. The thickness of this shielding is called the “Debye length” and the region inside this plasma shielding is called the “Debye sphere” (not necessarily near the wall) or the “Plasma sheath” for the region near the wall.

The Debye length is proportional to the square root of the electron temperature and inversely proportional to the square root of the plasma density. For example: consider a rough estimate of this length using the ion density of 1.0E+15 particles per cubic meter (“#/m³”) and the electron temperature of 10 KeV with the result obtained being about 2.3 cm for the Debye length (or thickness of ion clouds). If the plasma temperature, especially of electrons, is increased without changing its density, expansion of the Debye length or sheath thickness should be observed. On the other hand, if the plasma density is increased without changing temperature, then the shrinkage of the Debye length or sheath thickness should be observed.

In the plasma sheath, there is a potential gradient due to the difference in the electron and ion velocities. The sheath created on the negative electrode tends to repel the excessive incoming electrons and the sheath created on the positive electrode tends to repel the excessive incoming ions. This shielding results in the steady state of the ion and electron densities inside the sheaths.

Referring to FIG. 2D before describing FIG. 2C, FIG. 2D shows the volt-ampere characteristic of a Langmuir electrostatic probe as a possible explanation of the change in the saturation that appears to occur from supplying the electromagnetic radiation to the asymmetric capacitor. The current is not to scale correctly, as the actual electron current is much larger (such as three orders of magnitude) than that of ions.

To generate the graph, a voltage applied to a probe (not shown) is varied and the current collected by the probe is measured. Vf is the plasma floating potential (i.e. the probe potential for net zero current) and Vp is the plasma potential. An analogy of this characteristic can be made to the asymmetric capacitor case. Consider the point of Vf as the condition just before the voltage is applied to the system, i.e., zero. If a variable voltage is applied to the system, the following is likely going to happen. At the initial stage, the current increases since both the ion and electron currents increase. This is seen by the line of V-I characteristic from Vf toward B for the negative electrode and from Vf toward C for the positive electrode. When the applied voltage reaches to the point that the potential of the negative electrode becomes −Vf, the ion current reaches its steady state, i.e., ion current saturation. This current is called the “Bohm current.” This steady state is reached, although the total current still increases since the electron current is still increasing at the point that the potential of the positive electrode is +Vf, assuming that Vp−2Vf>0. When the applied voltage reaches to the point that the potential of the positive electrode becomes Vp, then the total current saturates since the electron current reaches to its steady state. However, if the applied voltage is further increased to the value that the potential drop inside the plasma sheath is greater than the potential energy to ionize atoms, then the current increases abruptly at point D. In some capacitors without the improvements disclosed herein, point D corresponds to a range from 23 kV to 30 kV. Increasing voltage beyond that point does not yield a substantial and corresponding benefit.

Consider two different example asymmetric capacitor performances with different applied voltages, 1 gram/watt for 30 KV as case 1 and 324 grams/watt for 110V as case 2, can be located on the V-I characteristic curve. Case 2 is located at a point somewhere on the curve between Vf and C for the positive electrode and at a point somewhere on the curve between Vf and B for the negative electrode. In some cases, the point could be left from the point B but generally should be symmetric to the point for the positive electrode to achieve larger forces.

Case 1 is located at a point somewhere on the saturated electron current state, i.e., between C and D for the positive electrode and at the symmetric point to the left for the negative electrode. It is believed that photo-ionization, heating, or a combination thereof using UV, IR or RF or other electromagnetic radiation of O₂ and N₂ molecules raises the energy levels sufficiently, to cause one or more electrons to leave the respective atom (herein “ionization”) which will ready the particles for manipulation by electrical fields in the same way as similar molecules ionized by high-voltage. Sufficient energy creates a plasma. It is believed that ionization changes the saturation of space-charge-limited current, since it appears that ionization should change the plasma density and change the plasma state inside the sheath. Now, looking at this V-I characteristic curve, ionization will increase the plasma potential Vp as well as Vf Therefore, the curve will be shifted to the right. This shifting will increase the values of the saturated current. The Bohm current is expressed as

$${I}_{( ion )} = \frac{1}{2} {n}_{0} {eA ( \frac{{KT}_{e}}{M} )}^{\frac{1}{2}}$$

where n₀ is the background plasma density, e is electron charge, A is the surface area of the probe, K is Boltsmann's constant, Tₑ is electron temperature, and M is the ion mass. This equation also indicates that the saturated value of the ion current can be increased by increasing plasma density and electron temperature. It is believed that this is also true for the electron current.

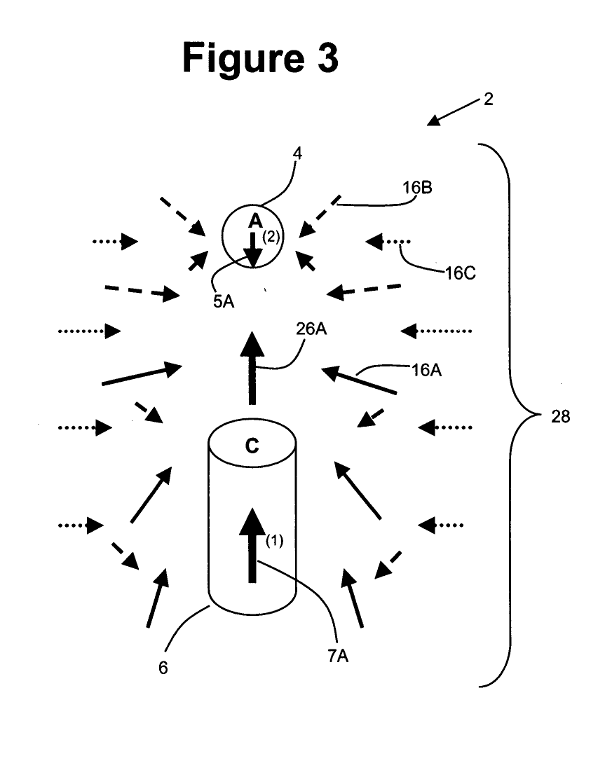

FIG. 2C is a charged particle schematic diagram of the enhancement of the present invention with electromagnetic radiation illustrating the resulting increased particle density and velocity. The velocity is increased by an increase in energy. Ionization by use of UV and/or IR light can create a weakly ionized (i.e. partial) plasma. Further, UV and/or IR light as a form of electromagnetic radiation can increase the plasma density significantly. In addition to applying electromagnetic radiation from an electromagnetic radiation source 20, if some other methods to heat the plasma are applied, the value of the saturated current will further increase. The plasma heating can be performed independently from plasma density increase by an application of electromagnetic radiation of a different frequency by another electromagnetic radiation source 20A. Advantageously, both plasma density increase and plasma heating can be utilized by using multiple frequencies from sources 20, 20A. In one embodiment, the sources 20, 20A can be a single unit capable of radiating multiple wavelengths, or multiple units. Total momentum (p) imparted to neutral particles by transfer from charged particles is the product of mass×velocity (p=mv). Therefore, total momentum transfer to neutral particles (shown in FIG. 3 as particles 16A, 16B, 16C) from charged particles 16 in FIG. 2c has both a greater number for greater mass within the region 28 and higher energy due to the temperature increase for greater velocity.

There are several methods to add energy to a plasma. One of them is to use radio frequency (RF) electromagnetic radiation. In this method, there can be generally three different frequency ranges to apply: an electron cyclotron frequency, a lower hybrid frequency, and an ion cyclotron frequency. Another approach is to use the method of neutral beam injection into the plasma. In this method, high-speed neutral particles are injected into plasma and these energetic neutral particles become energetic (high speed) ions by losing electrons through collisions with less energetic (low speed) ions, which in turn become low speed neutral particles by receiving those electrons. This method, however, requires a device to create such a high-speed neutral beam and this in turn requires a large power supply. On the other hand, the RF heating of plasma can be achieved by using a magnetron and a power source similar to, for example, a microwave oven.

These mentioned heating methods use external sources. Without those external sources, it is reasonable to expect that some heating of the plasma can be done internally by Ohmic heating and heating by compression due to magnetic pressure in the system. However, Ohmic heating becomes less effective as the plasma temperature increases since the plasma resistivity inversely depends on the 3/2 power of its (electron) temperature. Therefore, it will be very effective to use an external source of heating at this point. After the current in the system increases by this method, then the plasma can be further heated by magnetic compression, because it is expected that quite a strong magnetic field is created in the system at this point. Sequencing or joining these different methods of heating can be a very efficient method of systematic heating.

In at least one embodiment, the present disclosure uses UV and/or IR photo-ionization combined with RF heating. Increasing the plasma density, especially in combination with increasing the plasma energy and therefore velocity and equivalent temperature, using the methods outlined above will enhance the motive force of the system. The increase in the net force 26 (not to scale) is illustrated as larger in FIG. 2C compared to FIGS. 2B, 2A. It is believed that such methods can enhance the motive force by several orders of magnitude.

In addition to a medium having particles in which the asymmetric capacitor 2 operates, other gases can be provided to the asymmetric capacitor to supplement the medium or in lieu of the medium. The need for supplementation can occur for example, when the medium is space or other no or low particle media. For example, hydrogen or helium could be used with the advantages of being independent of the atmosphere, having reduced UV or IR wavelength complexity to a single frequency for the UV or IR photo-ionization, and permitted RF frequency optimization for hydrogen ion temperature increased effect. Further, a combination of gases could be substituted in place of a single gas. Still further, particles such as vaporized mercury or other particles useful to create and maintain propulsive and other forces could be injected into a volume in which the asymmetric capacitor operates.

FIG. 3 is a schematic diagram of a motive force of neutral particles momenta experiencing collisions with charged particles. This diagram illustrates the how the neutral particles contribute to the net force with the capacitor. It illustrates the primary force derivation as momentum transfer from charged particles 16 in FIG. 2B, 2C to neutral particles 16A, 16B, 16C. Particles 16A with an upward vector have a positive contribution to the upward thrust. Particles 16B with a downward vector have a negative contribution to the upward thrust. Particles 16C with only a horizontal vector have no contribution to the thrust. The net force 5A on the first electrode 4 is generally downward, the net force 7A on the second electrode 6 is generally upward and the resultant new force on the asymmetric capacitor 2 is the vector sum of forces 5A and 7A to result in net force 26. This force can be related to thrust acting on the physical propulsion unit. Some additional force may derive from ion jets and associated air pumping by redirected charged particles.

In addition, further efficiency can be realized by producing a pulsed power, instead of steady power. The system can pulse the electromagnetic radiation applied to the particles, the voltage applied to at least one of the electrodes, or a combination thereof. Several options exist to produce the pulsed power. Pulsed power can be more efficient, as it decreases the average energy consumption. For example and without limitation, experiments and modeling of a standard asymmetric capacitor powered by ˜25 kV DC steady state at ˜1 mA demonstrate no measurable reduction in force when the applied power is pulsed (˜100 Hz timing with ˜10 ms pulse duration).

Another variation is to control the surface area on one or more of the electrodes by the surface texture, porosity, or openings provided therethrough. For example, the surface area on an electrode can be increased by providing openings through the electrode. Advantageously, the openings can be located in the electrode to assist in affecting the flow of particles into and out of the field between the electrodes.

Further, an oxide or other material can be used to coat the electrodes to increase force by supplying a source of additional particles. The coating can be bombarded with energetic ions and neutral particles and coating particles will be added to the other particles in the plasma.

The asymmetric capacitor can function as an “engine” for a structure coupled to the capacitor or to direct energy emanating from the capacitor. The engine can be used in virtually any field, including without limitation, air, land, space (enhanced by injecting particles into the engine system) and sea vehicles, both manned and unmanned, and virtually any device or system that needs a motive force to move or a volume of energy that can be emanated and directed from the capacitor. Further, the present invention can apply to small items, including nano-sized items and to relatively large items. Another use for the invention is to generate a flow of energy or plasma directed outward from the apparatus.

In at least one embodiment, the asymmetric capacitor has few, if any, moving parts and the engine can be turned off and on at will with little concern for idling as found in typical rotational engines producing motive power. The present invention using the atmospheric air, and/or a discrete medium, such as hydrogen, helium or another medium in the place of atmospheric air, has the characteristics of a “digital” thrust system in that it can be solid state with little to no analog components, such as pumps, ignition systems, fluid fuel control, compressors, turbines and nozzle controls. Electrical energy from fuel cells can be switched to cathode and anode, UV and/or IR solid state light emitting diodes and lasers, and solid state RF emitters. Thrust can be controlled from any value starting at zero to maximum on a timeline commensurate with overall vehicle control system demands. The analog equivalent usually has a sustained starting cycle, and may also have a minimum idle condition and an acceleration timeline significantly longer than overall control system requirements might require. Thus, the asymmetric capacitor with the improvements herein as a motive force engine can be termed a “digital” engine.

Further, the system can include portable power for the asymmetric capacitor 2 and/or the electromagnetic sources 20, 20A. One method of providing portability is to use chemical-to-electrical power conversion. Such techniques include, among others: fuel cells powered by hydrogen, paraffin, petroleum and other fuels; photon capture or solar panels; artificially enhanced photosynthesis; and genetically modified organisms. Other techniques include solar power, stored energy such as in batteries, controlled fusion or fission, and other sources that can provide a power supply from a fixed location attached to a mobile object using the asymmetric capacitor in the manner disclosed herein. The term “fixed location” is used broadly and includes for example the ground, a fixed structure, or a structure in motion in a different direction or velocity relative to asymmetric capacitor and any structure coupled to the capacitor.

Performance prediction, optimization and tuning can be accomplished empirically. Another approach is to use a plasma simulation. Issues related to analysis of this system are highly nonlinear and it appears that a magneto-hydrodynamic (MHD) treatment of plasma is appropriate, because the time evolution of plasma around the electrodes complicates the structure of the electric and magnetic field in a self-consistent way. Since the plasma in this system is a weakly ionized, partial plasma, a two-fluid or three-fluid MHD treatment may be useful to predict performance. The kinetic treatment of plasma is probably not necessary for this issue, because the velocity distributions of electrons and ions are believed to behave as a Maxwellian distribution. However, this treatment can be useful in designing a more practical device in terms of efficiency, upscale, and control, since the energy losses due to radiation, including blackbody, Bremsstrahlung, and impurity radiation, and the micro-instabilities in the plasma that the MHD treatment cannot predict can be considered.

### EXAMPLE 1

In at least one embodiment, electromagnetic radiation, such as photonic (including UV and/or IR) and RF energy can be delivered into a volume of the asymmetric capacitor system. The electrodes can be at least partially copper, aluminum, or other conductive material. One or more porous electrodes can be used to increase the total surface and the Bohm current. One or more (such as an annular array of LEDs) electromagnetic radiation sources are attached to locations above the anode, between the anode and cathode, under the cathode or any combination thereof to energize particles between the electrodes (that is at least somewhere in the surrounding fields of the electrodes). A further electromagnetic radiation source can be an RF emitter device using pulsed magnetrons with variable frequency. In some embodiments, 10 kW pulsed magnetrons with variable frequency are preferred. A commercial-off-the-shelf laser or LED array and RF device may be used. Advantageously, the method of attachment of the electromagnetic radiation sources to the asymmetric capacitor allows the sources to treat the plasma uniformly. A commercially available laser uses the 248 nm laser line with high energy femtosecond pulses to ionize air (possibly on the order of 10¹¹ #/cm³) and also uses a longer wave length laser (such as a 750 nm infrared laser) to stabilize the plasma. By stabilize, the term is intended to mean that this relatively longer wave length laser reduces or prevents the plasma from neutralizing itself through recombination of the ions. However, the frequency generated from this device needs to be varied in order to heat the surrounding plasma uniformly, because the electron cyclotron frequency and ion cyclotron frequency depend on the magnetic field intensity and it is expected that this intensity varies in the system. Waveform modulation of the DC current enhances ionization. Performance tuning is enhanced by variable output current voltage.

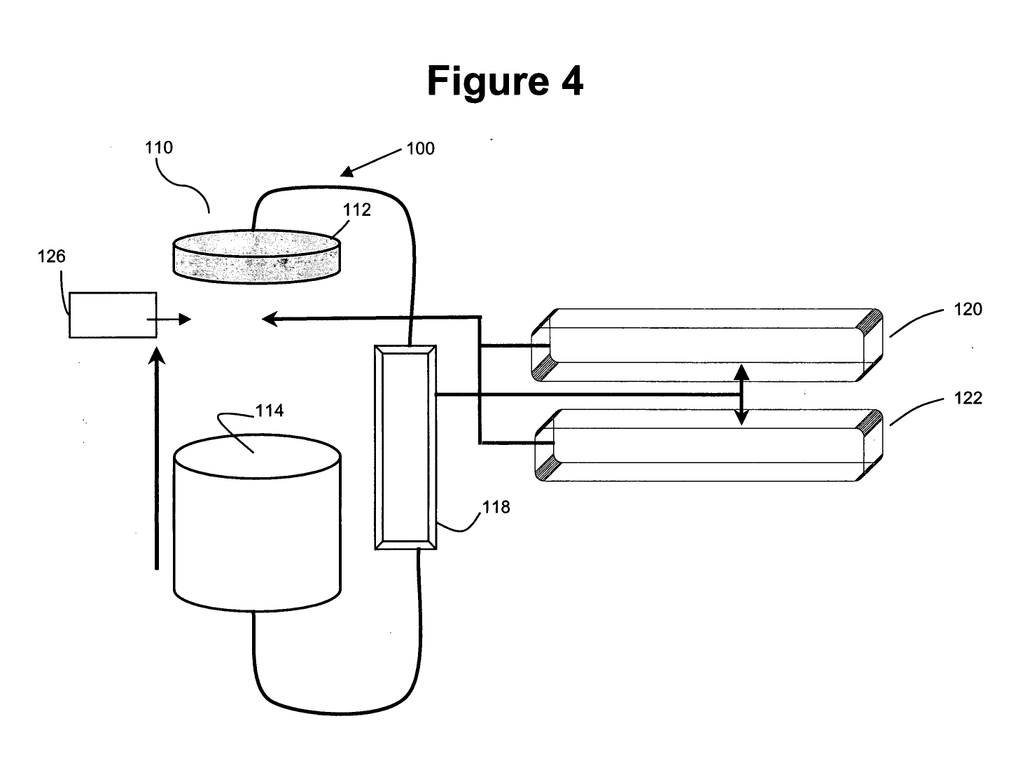

FIG. 4 is a schematic diagram of one embodiment of an asymmetric capacitor engine 100. The components listed are merely exemplary and without limitation. Other components can be substituted, added, or subtracted therefrom. In general, the engine 100 includes an asymmetric capacitor 110, including an anode 112 and a cathode 114, as described above. One or more sources of electromagnetic radiation 120, 122 can be used to provide radiation of one or more wavelengths to particles in a volume in proximity to the electrodes, also as described above. For example and without limitation, the electromagnetic radiation source 120 can include a photonic source of UV or IR light provided by one or more lasers. Similarly and without limitation, the electromagnetic radiation source 122 can include an RF source, such as can be provided by one or more magnetrons. The frequency generated from this device can be varied in order to heat the surrounding plasma uniformly, because the electron cyclotron frequency and ion cyclotron frequency depend on the magnetic field intensity and this intensity varies in the system. A power supply 118 can be coupled to the asymmetric capacitor 110 to provide power to at least one of the electrodes. The power supply 118 can be any suitable power supply capable of delivering the energy to the anode and cathode. The power supply 118 can also provide energy to one or more of the electromagnetic radiation sources 120, 122. Alternatively, the power supply can be multiple units capable of delivering the power to the individual elements. A source 126 of particles can be coupled to the asymmetric capacitor to provide particles in addition to particles in the media in which the engine operates or in lieu of such particles. For example, the source can be a compressed gas cylinder or other storage device for a supply of particles.

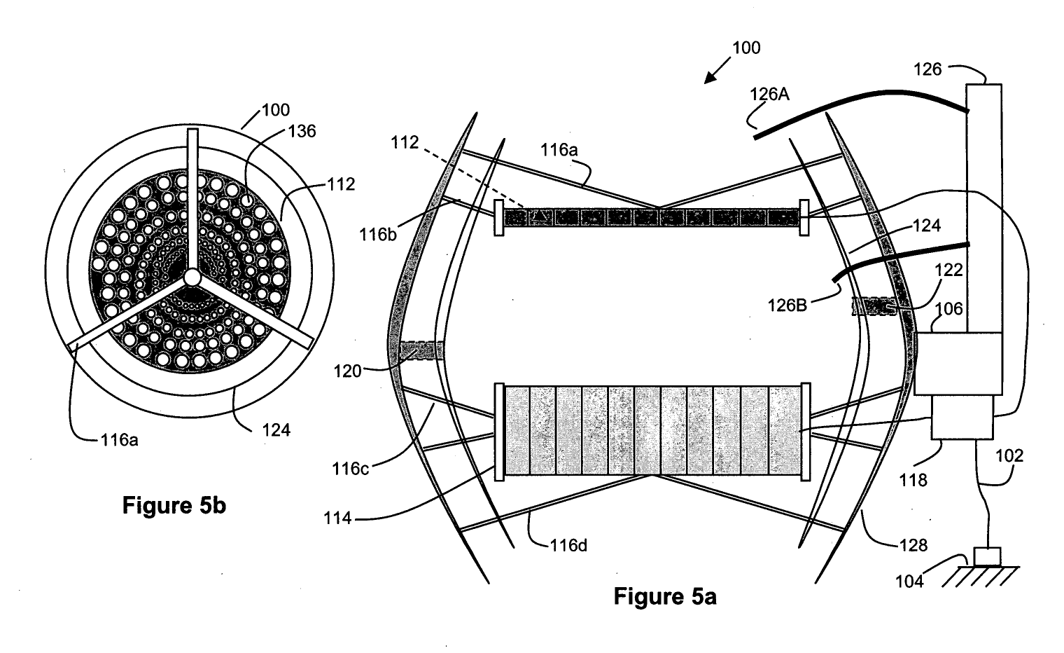

FIG. 5a is a schematic diagram of a cross sectional view of one embodiment of a system using the asymmetric capacitor. The engine 100 includes an asymmetric capacitor 110 having an anode 112 and a cathode 114. In one embodiment, the anode can be made from one or more highly porous relatively thin disks, blades, or wires, compared to the cathode, which generally has a larger surface area. Without limitation, the cathode 114 can be made from a highly porous relatively thick aluminum disk. The level of porosity is determined based on the limit of structural integrity of the system including electrodes, and other considerations such as stability. The electrode surfaces can be coated with a material such as oxide film or other coating to further increase performance.

An electromagnetic radiation source 120, such as a laser or LED device can be any suitable laser or other device delivering the required wavelength to the particles that are to be ionized. For such particles, exemplary wavelengths could be without limitation in the UV and IR range such as less than or equal to 1024 nm for O₂ and less than or equal to 798 nm for N₂. An electromagnetic radiation source 122, such as an RF heating device, can also be used, as described above.

Further, one or more reflectors 124 can be positioned in or around the area to be ionized. The reflectors can increase the efficiency of the laser device and/or RF heating device by more uniformly photo-ionizing molecules and heating the plasma and by redirecting the energy otherwise dissipated away from the fields of the capacitor. Generally, one or more supports 116a, 116b, 116c, 116d will support the anode, cathode, reflectors, or any combination thereof, either directly or indirectly through other supports being coupled to other surrounding structures, such as an engine case 128. The engine 100 can further be coupled to a larger structure, described below. To facilitate the coupling, one or more engine supports 106 can be used.

A power supply 118 can supply power to the anode 112, cathode 114, electromagnetic radiation source 120 (such as a laser or LED), electromagnetic radiation source 122 (such as an RF source), or any combination thereof. A particle source 126 can be coupled directly or indirectly to the asymmetric capacitor 110 to provide supplemental or primary particles (such as in space) to the capacitor. One or more injection nozzles 126A and/or 126B can direct the particles from particle source 126 to either the intake or volume between the electrodes to provide uniform and controlled particle injection. A power conduit 102 can be provided from a fixed location 104. Alternatively, the power supply 118 can be a portable power supply that is self-contained independent of a fixed location for at least some time period before refurbishing or recharging can be performed.

FIG. 5B is a top view schematic of the embodiment shown in FIG. 5A. In at least one embodiment, the anode 112 and/or the cathode 114 of the engine 100 can include one or more openings 136 in order to increase the exit surface area of the particular electrode or electrodes having the openings. The openings can be arranged in a pattern to create a vortex ring or other patterns to enhance the efficiency and resulting force of the capacitor. The openings 136 can allow air or other media in which the cathode or anode operates to pass through the electrodes into the region between the anode, cathode, or both. The increased surface area can provide greater efficiency to the engine 100.

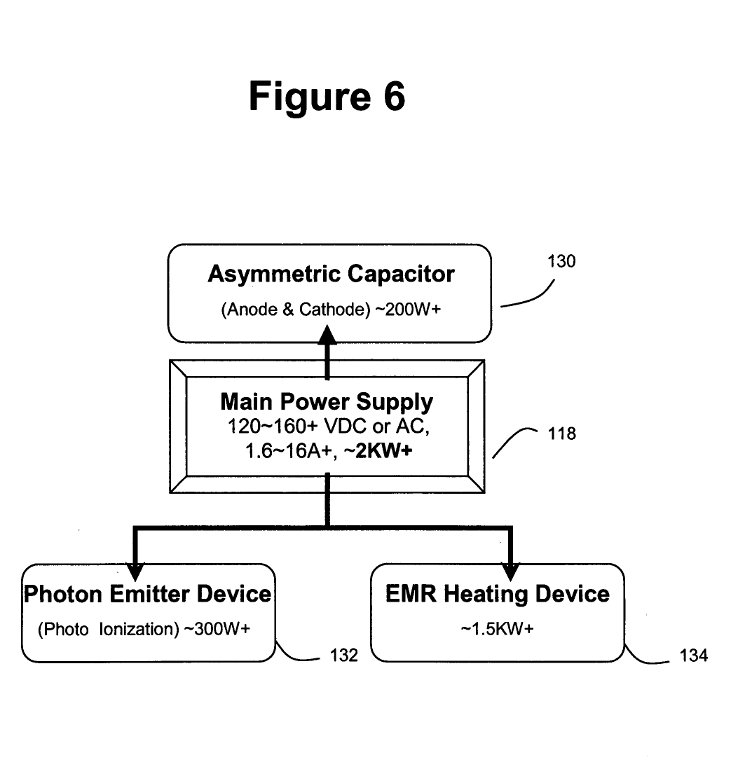

FIG. 6 is schematic diagram of the power budget for one exemplary embodiment. The power supply 118, referenced above, can be used to supply power to the asymmetric capacitor through a first power supply portion 130, specifically to the anode and cathode, referenced above. Without limitation, one exemplary wattage range is about 200 watts (W) or greater but such values can be scaled appropriately to optimize performance for the specific application. A second power supply portion 132 can be used to provide power to the laser device or LED array, referenced above. Similarly, one exemplary power range is about 300 W or greater. A third power supply portion 134 can be used to supply power to the RF heating device, referenced above. One exemplary power range can be about 1500 W or greater for this embodiment. The power supply portions can be formed as a unitary power supply or as multiple power supplies. Naturally, other embodiments can have different power budgets and this embodiment is only illustrative.

The disclosure provides for a structure to be coupled to the asymmetric capacitor so that a motive force from the asymmetric capacitor can provide a thrust to the structure. The structure can support equipment, one or more persons or other living organisms, or other items of interest, herein broadly termed “payload.”

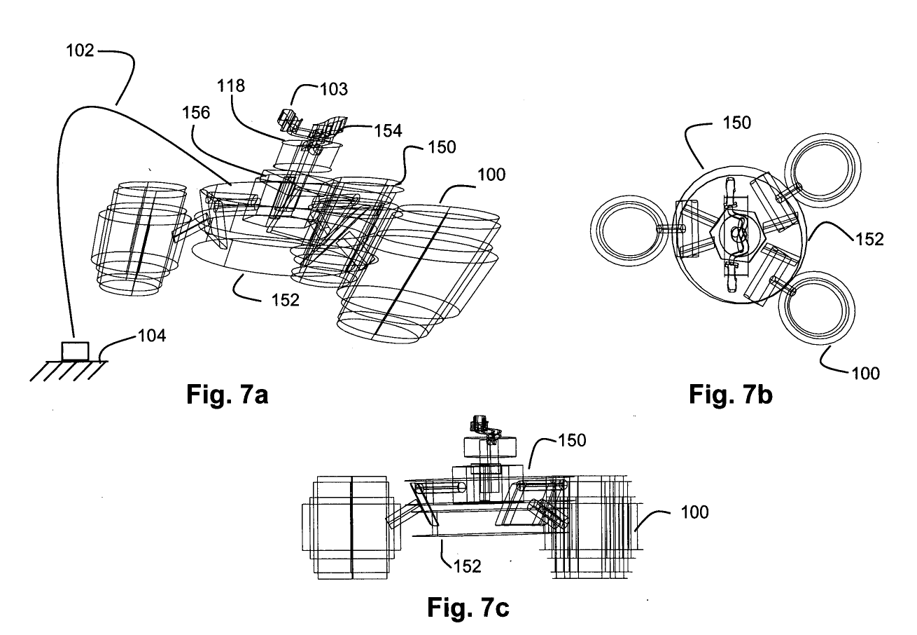

FIG. 7A is a schematic perspective view of one embodiment of an unmanned aerial vehicle (UAV). FIG. 7B is a schematic top view of the embodiment of FIG. 7A. FIG. 7C is a schematic side view of the embodiment of FIG. 7A. The figures will be described in conjunction with each other. The UAV 150 includes a frame 152 coupled to one or more asymmetric capacitor engines 100. Each engine can be in the form of an engine described above with an anode, cathode, and one or more electromagnetic radiation sources such as one or more photon emitter devices (such as lasers) and heating devices or some combination thereof. The UAV also includes various electronics 154 suitable for control of the UAV. In at least one embodiment, power can be supplied to the UAV through a power conduit 102, which can be coupled to a remote power supply such as on ground level or other fixed location 104. In some embodiments, the power supply 118 can be provided on the UAV itself. The UAV also includes sensors 156, 103 to accommodate image, electromagnetic, and data capture for processing and display.

Advantageously the UAV 150 can include three engines, although more or less engines can be used. The three engines assist in providing planar control, such as pitch, roll, and perhaps yaw, of the UAV.

One advantage of the UAV and other items powered by the engine 100 is the relatively low acoustic, electromagnetic, and/or radar cross-section signature. This feature can be particularly useful for certain vehicles and craft.

Naturally, other embodiments could include manned aerial or ground hover vehicles, and guided vehicles, as well as a host of other items on land, in or under the sea, or in the air, or in space. The present invention creates a universal motive force system, generally used for propulsion. The invention can also generate a flow of energy or plasma directed outward from the apparatus. In one embodiment, the engine has no moving parts and can reduce total cost of ownership including acquisition and maintenance costs.

In at least one embodiment, some exemplary design characteristics are variable and extensive range; variable speed and high speed capability; low acoustic, electromagnetic and RCS signature; variable pulsed power supply, in the range of about 120˜160+ VDC or VAC, 1.6˜16+ A, ˜2+ kW; and low maintenance due to few if any moving parts with some light maintenance to the nodes due to erosion.

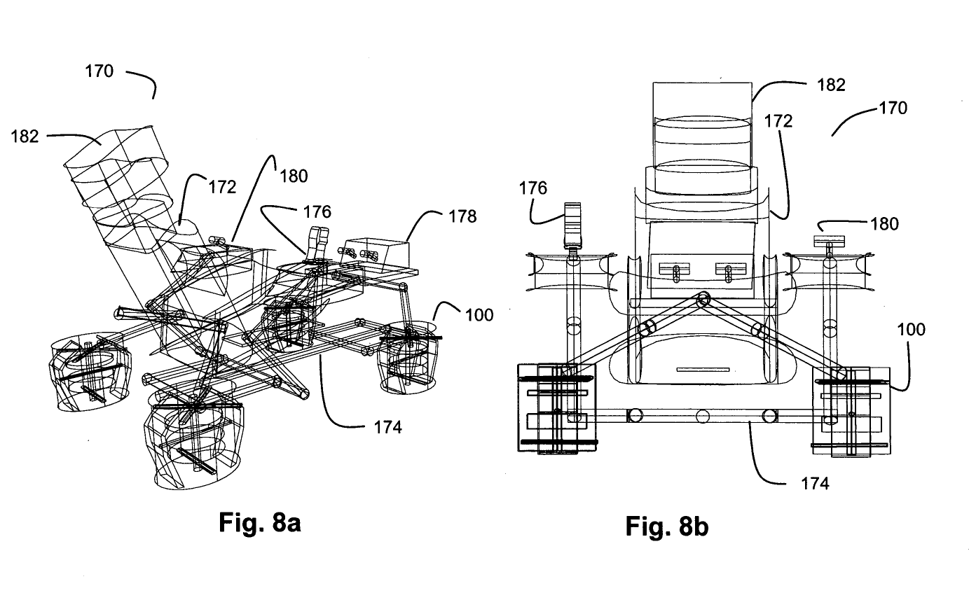

FIG. 8A is a schematic perspective view of one embodiment of a manned aerial vehicle (MAV) 170. FIG. 8B is a schematic front view of the embodiment of FIG. 8A. The figures will be described in conjunction with each other. The MAV can also be used as a ground hover vehicle. The MAV 170 generally includes a frame 172, a subframe 174, and one or more engines 100 coupled thereto with appropriate controls. The frame 172 is generally shaped and sized for one or more persons. The ergonomics can vary and in at least one embodiment can resemble an aircraft flight seat. The subframe 174 is formed of structural elements and is coupled to the frame 172. The subframe 174 can provide support for the one or more engines 100 coupled to the MAV 170. The engines can be mounted at various elevations, such as below or above the frame 172 or at an elevation therebetween. In some embodiments, a higher elevation may provide greater stability by having a lower center of gravity of the payload.

Although the number of engines can vary, advantageously multiple engines 100 can provide positional control for the MAV 170. In at least one embodiment, the engines 100 can tilt in one or more axes relative to the subframe 174 to supply a variety of thrust vectors. Such tilt can be automatic or manual.

The positional control can be done automatically, manually, or a combination thereof. For example, a controller 176, such as a “joystick,” can provide planar control, such as pitch and roll control. A controller 178 can provide yaw control and be actuated by an operator's feet on the MAV 170. The controllers can include the necessary electronics, cabling, control wires, and other components as would be known to those with ordinary skill in the art. Further, the MAV 170 can include a power controller 180 to control the power to the one or more engines 100. Further, control of the MAV 170 can be augmented using gyroscopes or other stability control systems.

In some embodiments, the MAV 170 can also include a recovery chute 182. The recovery chute can be applied in an emergency for the safety of the person or persons on the MAV.

Various basics of the invention have been explained herein. The various techniques and devices disclosed represent a portion of that which those skilled in the art of plasma physics would readily understand from the teachings of this application. Details for the implementation thereof can be added by those with ordinary skill in the art. The accompanying figures may contain additional information not specifically discussed in the text and such information may be described in a later application without adding new subject matter. Additionally, various combinations and permutations of all elements or applications can be created and presented. All can be done to optimize performance in a specific application.

The term “coupled,” “coupling,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include integrally forming one functional member with another.

The various steps described herein can be combined with other steps, can occur in a variety of sequences unless otherwise specifically limited, various steps can be interlineated with the stated steps, and the stated steps can be split into multiple steps. Unless the context requires otherwise, the word “comprise” or variations such as “comprises” or “comprising”, should be understood to imply the inclusion of at least the stated element or step or group of elements or steps or equivalents thereof, and not the exclusion of any other element or step or group of elements or steps or equivalents thereof.

Further, any documents to which reference is made in the application for this patent as well as all references listed in any list of references filed with the application are hereby incorporated by reference. However, to the extent statements might be considered inconsistent with the patenting of this invention such statements are expressly not to be considered as made by the applicant(s).

Also, any directions such as “top,” “bottom,” “left,” “right,” “upward,” “downward,” and other directions and orientations are described herein for clarity in reference to the figures and are not to be limiting of the actual device or system or use of the device or system. The device or system may be used in a number of directions and orientations.

### REFERENCES

1. Szielasko, Klaus, High Voltage “Lifter” Experiment: Biefeld-Brown Effect or Simple Physics?, Genefo, April 2002.
2. Stein, William B., Electrokinetic Propulsion: The Ionic Wind Argument, Purdue University, Energy Conversion Lab, Sep. 5, 2000.
3. Bahder, Thomas B. and Bazi, Chris, Force on an Asymmetric Capacitor, Army Research Laboratory, Sep. 27, 2002.
4. Bahder, Thomas B. and Bazi, Chris, Force on an Asymmetric Capacitor, Army Research Laboratory, March 2003.
5. Bilen, Sven, G., Domonkos, Mathew T., and Gallimore, Alec D., The Far-Field Plasma Environment of a Hollow Cathode Assembly, University of Michigan, AIAA Conference, June 1999.
6. Canning, Francis X., Melcher, Cory, and Winet, Edwin, Asymmetrical Capacitors for Propulsion, Glenn Research Center of NASA (NASA/CR-2004-213312), Institute for Scientific Research, October, 2004.

1. A method of providing a force with an asymmetric capacitor, comprising:
a. applying electromagnetic radiation to particles in a media in proximity to an asymmetric capacitor having at least two electrodes of different surface areas and separated by a distance; and
b. applying voltage to at least one of the electrodes to generate a net force with the asymmetric capacitor.

2. The method of claim 1, wherein applying the electromagnetic radiation to the particles ionizes at least a portion of the particles between the electrodes.

3. The method of claim 2, wherein applying the electromagnetic radiation to the particles creates a plasma between the electrodes.

4. The method of claim 3, further comprising stabilizing the plasma with a longer wavelength electromagnetic radiation than a wavelength used to create the plasma.

5. The method of claim 1, wherein applying the electromagnetic radiation to the particles increases a particle density for a given volume, a plasma energy, or a combination thereof.

6. The method of claim 1, wherein applying the voltage comprises applying a lower voltage to the capacitor with the electromagnetic radiation applied to the particles compared to an applied voltage without the electromagnetic radiation for a given net thrust force.

7. The method of claim 1, wherein applying the electromagnetic radiation comprises applying the radiation to the particles prior to applying the voltage to the asymmetrical capacitor.

8. The method of claim 1, wherein applying the electromagnetic radiation comprises applying ultraviolet radiation, infrared radiation, or a combination thereof.

9. The method of claim 8, wherein applying the electromagnetic radiation comprises applying the radiation at a frequency that ionizes the particles by photon emission.

10. The method of claim 1, further comprising increasing a plasma density of particles in the asymmetric capacitor by applying ultraviolet radiation, infrared radiation, or combination thereof to the particles.

11. The method of claim 1, further comprising generating the net force in a direction from a smaller electrode to a larger electrode of the asymmetric capacitor.

12. The method of claim 1, wherein the asymmetric capacitor is coupled to a structure and further comprising providing thrust to the structure.

13. The method of claim 12, further comprising allowing the asymmetric capacitor to rotate to a plurality of orientations relative to the structure to provide a plurality of thrust vectors.

14. The method of claim 1, further comprising supplying particles to the asymmetric capacitor to develop at least a portion of the net force independent of a medium in which the engine operates.

15. The method of claim 1, further comprising reflecting the electromagnetic radiation into a volume in proximity to the electrodes.

16. The method of claim 1, further comprising pulsing the electromagnetic radiation to the particles, the voltage to at least one of the electrodes, or a combination thereof.

17. The method of claim 1, further comprising switching the electromagnetic radiation from an off-state to an on-state back to an off-state.

18. The method of claim 1, further comprising operating the asymmetric capacitor in air and acting on air particles to generate the net force.

19. The method of claim 18, further comprising supplementing the particles of air with selected supplemental particles.

20. The method of claim 19, wherein the supplemental particles are gaseous.

21. The method of claim 1, further comprising operating the asymmetric capacitor in a medium at less than atmospheric pressure at standard conditions and providing supplemental particles to generate the net force.

22. The method of claim 1, further comprising providing portable power to the asymmetric capacitor.

23. The method of claim 1, further comprising operating the asymmetric capacitor in a liquid medium, wherein the liquid is delivered to the asymmetric capacitor in a vaporized form.

24. The method of claim 1, wherein the net force is a thrust force to move the asymmetric capacitor and a structure coupled thereto.

25. The method of claim 1, further comprising modifying the net force by adjusting a surface area of at least one of the electrodes.

26. A method of increasing power output from an asymmetric capacitor, comprising:
a. ionizing particles with electromagnetic radiation in a medium between a first electrode having a first surface area and a second electrode having a second surface area different from the first surface area; and
b. applying a voltage to at least one of the electrodes and generating a net force with the electrodes.

27. The method of claim 26, wherein ionizing the particles with the electromagnetic radiation increases a plasma density for a given volume, a plasma energy, or a combination thereof.

28. The method of claim 26, wherein applying the voltage comprises applying a lower voltage to the capacitor with the electromagnetic radiation applied to the particles compared to an applied voltage without the electromagnetic radiation for a given net force.

29. The method of claim 26, wherein applying the electromagnetic radiation comprises applying ultraviolet radiation, infrared radiation, or a combination thereof.

30. The method of claim 29, wherein applying the electromagnetic radiation comprises applying the radiation at a frequency that ionizes the particles by photon emission.

31. The method of claim 26, wherein the asymmetric capacitor is coupled to a structure and further comprising providing thrust to the structure.

32. The method of claim 26, further comprising supplying particles to the asymmetric capacitor to develop at least a portion of the net force independent of the medium in which the asymmetric capacitor is disposed.

33. The method of claim 26, further comprising pulsing the electromagnetic radiation to the particles.

34. The method of claim 26, further comprising switching the electromagnetic radiation from an off-state to an on-state back to an off-state.

35. The method of claim 26, further comprising operating the asymmetric capacitor in air and acting on air particles to generate the net force.

36. The method of claim 35, further comprising supplementing the particles of air with selected supplemental particles.

37. The method of claim 26, further comprising operating the asymmetric capacitor in a medium at less than atmospheric pressure at standard conditions and providing supplemental particles to generate the net force.

38. The method of claim 26, further comprising modifying the net force by adjusting a surface area of at least one of the electrodes.

39. The method of claim 26, further comprising pulsing the electromagnetic radiation to the particles, the voltage to at least one of the electrodes, or a combination thereof.

40. A system for producing a force, comprising:
a. an asymmetric capacitor comprising a first electrode having a first surface area and a second electrode having a second surface area different from the first surface area;
b. a voltage source coupled to the asymmetric capacitor to apply voltage to the capacitor and generate a net force with the capacitor; and
c. an electromagnetic radiation source adapted to apply radiation to particles between the electrodes.

41. The system of claim 40, wherein the electromagnetic radiation source is adapted to provide energy to the particles in addition to energy supplied by the voltage to the capacitor.

42. The system of claim 41, wherein the electromagnetic radiation source is adapted to ionize at least a portion of the particles between the electrodes.

43. The system of claim 41, wherein the electromagnetic radiation source is adapted to create a plasma between the electrodes.

44. The system of claim 40, wherein the electromagnetic radiation source supplies electromagnetic radiation to the particles between the electrodes prior to applying the voltage to the asymmetrical capacitor.

45. The system of claim 40, wherein the electromagnetic radiation source comprises an ultraviolet radiation source, an infrared radiation source, or a combination thereof.

46. The system of claim 45, wherein the electromagnetic radiation source is adapted to increase a particle density for a given volume, a plasma energy, or a combination thereof in the asymmetric capacitor.

47. The system of claim 40, wherein the asymmetric capacitor is coupled to a structure and adapted to provide thrust to the structure.

48. The system of claim 47, wherein the asymmetric capacitor is rotatable to a plurality of orientations relative to the structure.

49. The system of claim 40, further comprising a particle supply coupled to the asymmetric capacitor and adapted to supply particles to the asymmetric capacitor independent of a medium in which the asymmetric capacitor operates.

50. The system of claim 40, wherein the electromagnetic radiation source supplies electromagnetic radiation at a frequency that ionizes particles by photon emission.

51. The system of claim 40, wherein one or more of the electrodes have openings formed therethrough to increase a surface area on the one or more electrodes.

52. The system of claim 40, further comprising one or more electromagnetic radiation reflectors coupled to the asymmetric capacitor.

53. The system of claim 40, further comprising:
a. a structure coupled to the asymmetric capacitor; and
b. a controller coupled to the structure.

54. The system of claim 53, further comprising a power supply coupled to the structure and tethered to a fixed ground location.

55. The system of claim 53, further comprising a portable power supply coupled to the structure to supply power to the asymmetric capacitor independent of a fixed ground location.

56. The system of claim 53, further comprising a particle supply coupled to the structure to supply particles to the asymmetric capacitor.

57. The system of claim 53, further comprising a plurality of asymmetric capacitors coupled to the structure and adapted to provide pitch, roll, and yaw control to the vehicle.

58. The system of claim 53, wherein the system is adapted to carry a payload.

59. The system of claim 53, wherein the electromagnetic source comprises a photon emitter directed toward a volume between the electrodes.

60. The system of claim 53, wherein the electromagnetic source comprises an electromagnetic radiation emitter directed toward a volume between the electrodes.
